(19) United States
(12) Patent Application Publication
(10) Pub. No.: US 2012/0195054 A1
(43) Pub. Date: Aug. 2, 2012

(54) Heat sink for an illumination device

(75) Inventors: Nicole Breidenassel, Bad Abbach (DE); Moritz Engl, Regensburg (DE); Markus Hofmann, Bad Abbach (DE); Giovanni Scilla, Fontane (Treviso) (IT)

(73) Assignee: OSRAM AG, Munchen (DE)

(21) Appl. No.: 13/321,820

(22) PCT Filed: May 19, 2010
(86) PCT No.: PCT/EP2010/056882

§ 371 Date: Apr. 5, 2012

(30) Foreign Application Priority Data
May 20, 2009 (DE) 10 2009 022 071.2

(51) Int. Cl. F21V 29/00

(52) U.S. Cl. 362/382

(57) ABSTRACT

A heat sink (2;16,17;22) for an illumination device (1;15;20), wherein the heat sink is made up of comprises several heat sink parts (3,4;16,17;23,27), wherein at least two of the heat sink parts (3,4;16,17;23,27) include different heat sink materials

The invention relates to a heat sink for an illumination device and an illumination device with such a heat sink.

In the case of many illumination devices, and in particular in the case of retro-fit lamps, a heat sink is used for the purpose of heat dissipation. This heat sink often consists of aluminum or some other metal with a high thermal conductivity. In the case of LED illumination devices, a circuit board fitted with one or more light emitting diodes (LEDs) can be mounted directly on the heat sink. The heat generated by the LEDs is then transmitted directly from the circuit board to the heat sink, and is given up to the surroundings by the heat sink. However, the use of such a heat sink has the disadvantage that it makes the lamp very heavy.

The object of the present invention is to provide a less heavy heat sink for an illumination device, in particular for retro-fit lamps.

This object is achieved by means of a heat sink and an illumination device in accordance with the relevant independent claim. Preferred embodiments can be derived, in particular, from the dependent claims.

The heat sink is intended for use with an illumination device, the heat sink being made up of several (i.e. two or more) heat sink parts. At least two of the heat sink parts consist of a different material, the respective heat sink material. The heat sink can thereby be subdivided into regions with different thermal conduction properties and/or different weights, and thus can be optimized for the required heat dissipation properties and overall weight. In principle, there is no restriction on the total number of heat sink parts and the number of the heat sink parts made of the same heat sink material. Thus the heat sink may, for example, have one heat sink part made of a first heat sink material, two heat sink parts made of a second heat sink material and one heat sink part made of a third heat sink material. The heat sink parts can be pre-manufactured and then put together, produced as a single piece (e.g. by injection molding or sintering) or produced by a combination of one-piece manufacture and assembly. For example, the manufacture would be possible by injection molding of a heat sink part made of a first metallic heat sink material with a second heat sink material made of plastic, which forms another heat sink part. By doing this, the assembly activity is eliminated.

For the purpose, in particular, of simple and low-cost manufacture at least one light source can be attached to at least one first heat sink part made of a first heat sink material, while at least one second heat sink part made of a second heat sink material has no light source attached to it. This make it possible, for example, for a first heat sink part to be designed for a high temperature close to the heat source, and a second heat sink part, possibly having a larger volume, for an appropriately lower temperature further away from the heat source.

In particular, the second heat sink material can have a lower thermal conductivity and/or be lighter (have a lower specific weight or density) than the first heat sink material. This makes it possible to use a heat sink material which better dissipates heat from the light source but which is also more expensive and/or heavier (for example, aluminum and/or copper) to be used in the space immediately around the light source, which has a comparatively small volume, while for the space further away, generally larger in volume, a cheaper and/or lighter heat sink material, which may in some cases have a comparatively lower thermal conductivity (for example made of plastic), is adequate. By this means it is possible to provide a heat sink which is lighter and cheaper by comparison with a heat sink whose whole volume consists of the first heat sink material.

For the purpose of effective heat dissipation, preference can be given to a heat sink for which the value of the thermal conductivity of the first heat sink material is more than 10 W/(m·K), in particular more than 20 W/(m·K), and especially more than 50 W/(m·K) and in particular more than 100 W/(m·K).

Here, the first heat sink material can include in particular a metal, a plastic and/or a ceramic. As the first heat sink material preference can be given to aluminum, copper and/or magnesium, or alloys of them. The use of a ceramic may also be preferred, e.g. AlN.

For the purpose of low-cost heat dissipation, preference can be given to a heat sink for which the value of the thermal conductivity of the second heat sink material is more than 1 W/(m·K), in particular more than 5 W/(m·K). Here, the second heat sink material can include in particular a plastic and/or a ceramic. As the second heat sink material, preference can be given to a heat-conducting plastic (e.g. PMMA or polycarbonate) or a ceramic.

There is in principle no restriction on the nature of the light source, but a semiconductor light source, in particular a light-emitting diode (LED) or a laser diode, is preferred as the emitter. The light source can have one or more emitters.

The emitter(s) can be affixed on a carrier on which can also be mounted further electronic modules, such as resistors, capacitors, logic modules etc. The emitters can, for example, be affixed to a circuit board by means of conventional soldering methods. The circuit board can be manufactured, for example, using FR4, FR2 or CEM1, or can be a flexible circuit board (‘flexboard’), e.g. made of polyimide or PEN. However, the emitters could also be connected on a substrate (“sub-mount”), using chip-level connection types such as bonding (wire bonds, flip-chip bonds) etc., e.g. by fitting LED chips onto an AIN substrate. It would also be possible to mount one or more submounts on a circuit board.

If several emitters are present they can radiate the same color, e.g. white, which permits simple scalability of the brightness. However, at least some of the emitter could also have a different radiation color, e.g. red (R), green (G), blue (B), amber (A) and/or white (W). By this means it is possible, if required, to adjust the radiation color of the light source, and a desired color point can be set. In particular, it can be preferable if emitters with different radiation colors can produce a white light mixture. It is generally also possible to use organic LEDs (OLEDs) instead of, or in addition to, inorganic light emitting diodes based, for example, on InGaN or AlInGaP. It is also possible to use, for example, diode lasers. In general, it is also possible to use other emitters, such as compact fluorescent, tubes etc.

To permit the flexibility to choose for example even an electrically conducting material as the first heat sink material, a heat sink may be preferable in which the second heat sink material is electrically insulating.

For efficient heat dissipation from the heat sink, at least one second heat sink part can be structured on its outer side, e.g. by cooling projections such as cooling fins, cooling pins etc. Alternatively or additionally, at least one second heat sink part can be coated to increase its heat dissipation, e.g. with a heater paint.

For further weight saving, and for improved heat dissipation, the heat sink in accordance with one of the preceding claims can have at least one through duct. By this, a ‘flue effect’ can be achieved, and in addition the volume of the solid can be reduced.

For the purpose of reducing the thermal resistance at the interface between heat sink parts, a heat sink may be preferred in which at least two heat sink parts are joined to each other, in particular are joined to each other over an area, by means of a heat conducting or thermal interface material (TIM).

For the purpose of reducing the thermal resistance at the interface between at least one heat source (light source, driver, etc.) and the heat sink, it may be preferred if at least one heat source is joined as applicable to the heat sink or the associated heat sink part, in particular is joined over an area, by means of at least one thermal interface material (TIM).

A first heat sink part can be joined over an area on one side to a second heat sink part, e.g. by means of the TIM material. Such a joint can be implemented particularly simply. In particular it can be preferred for this case too if the first heat sink part is designed to be plate-shaped, i.e. that the vertical extension is significantly less than its extension in the plane. The outer contour is not defined, and can for example have corners, especially be rectangular, in particular square, or for example can also be round or oval. The second heat sink part will preferably have a contact area corresponding to the first heat sink part.

A first heat sink part can also be joined by areas on several sides to a second heat sink part, e.g. by means of the TIM material. This has a higher associated cost than for a single face joint, but enables a thermal interface area to be enlarged. For this case in particular it can also be preferred if the first heat sink part is three dimensional in design, i.e. if the vertical extension is, for the purpose of heat dissipation, not negligible by comparison with its extension in the plane. The outer contour is not determined and can, for example, be in the shape of a cube or a cuboid. The second heat sink part will preferably have a corresponding recess for the first heat sink part.

For the purpose of achieving a compact form of construction at the same time as good heat dissipation from a driver (as a further heat source) for operating the light source, preference may be given to a heat sink for which at least a first heat sink part has a recess for accommodating a driver. The first heat sink part can advantageously be designed as a hollow body which is open on one side. On the hollow body's closed side, which is opposite the opening, on the side of it which faces away from the hollow body can be attached the light source, in particular a carrier (circuit board, substrate, or similar) for such a light source.

Also for the purpose of achieving a compact form of construction at the same time as good heat dissipation from a driver, preference may be given to a heat sink for which at least one second heat sink part has a recess for accommodating a driver. By this means, the driver can be integrated, directly or via the first heat sink part, into the second heat sink part.

For the purpose of efficient heat dissipation, a driver can in general be thermally joined to at least one heat sink part, e.g. by means of at least one TIM material.

The illumination device is equipped with at least one such heat sink, wherein at least one LED light source is attached to the heat sink. The illumination device can in particular be designed as a retro-fit lamp which is suitable for replacing conventional incandescent lamps and frequently approximates to the latter's external contour and which has a conventional socket for the power supply.

The illumination device can in particular have one or more ducts which are open to the outside, which at least partially incorporate the ducts in the heat sink. By this means, it is possible to achieve particularly efficient heat dissipation by a ‘flue effect’. If several ducts are present, these can have the same orientation, or different positions, sizes (lengths, widths) and/or shapes.

In the following figures, the invention is described schematically in more detail by reference to exemplary embodiments. Here, to give a better overview the elements which are the same or have the same effect have been given the same reference numbers.

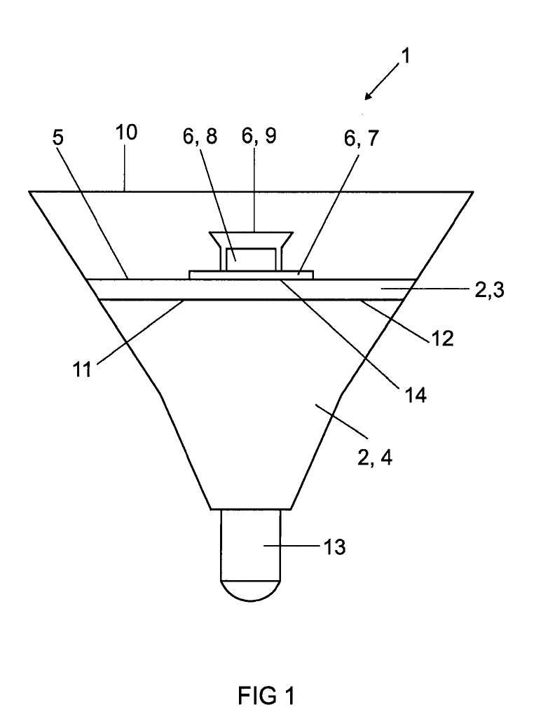

FIG. 1 shows a side view of a retro-fit lamp in accordance with a first embodiment, as a cross-sectional diagram;

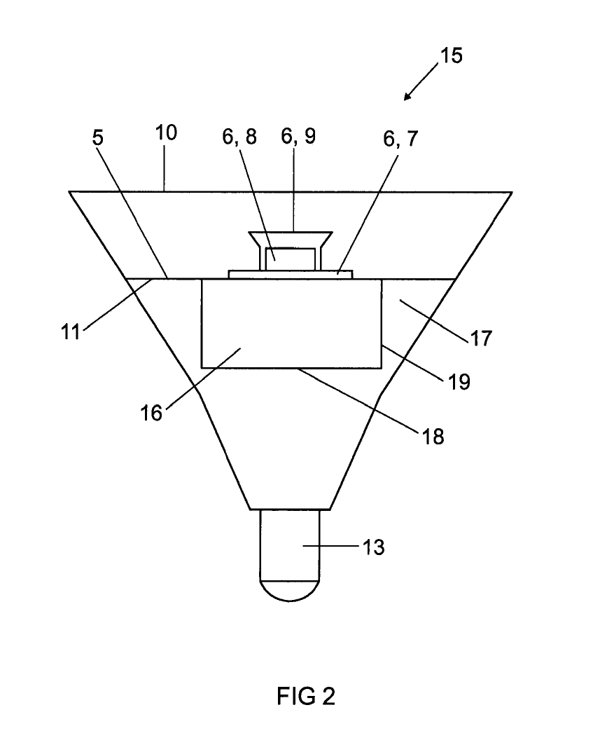

FIG. 2 shows a side view of a retro-fit lamp in accordance with a second embodiment, as a cross-sectional diagram;

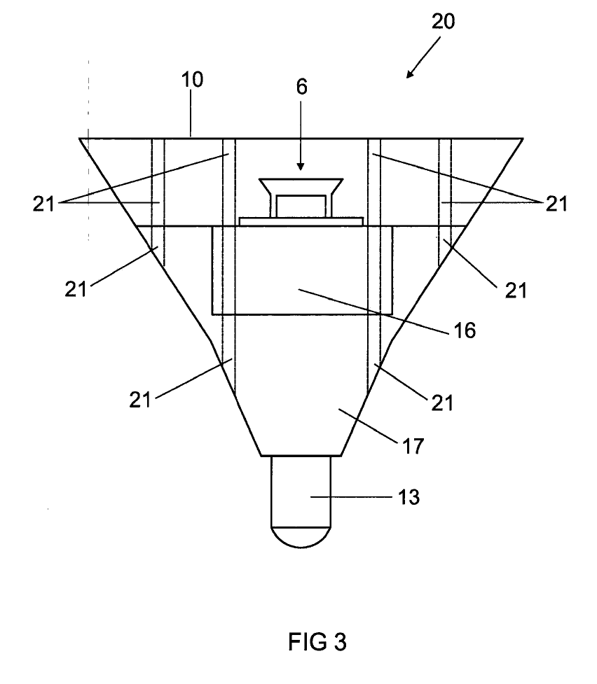

FIG. 3 shows a side view of a retro-fit lamp in accordance with a third embodiment, as a cross-sectional diagram;

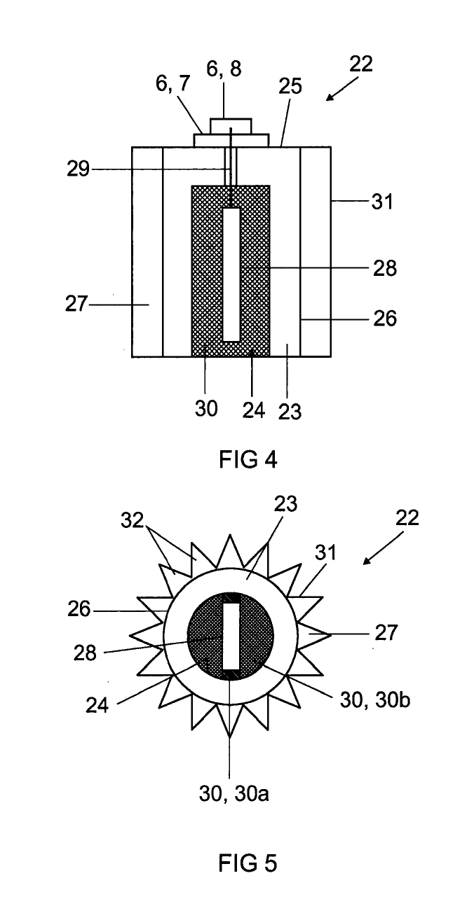

FIG. 4 shows a side view of a heat sink in accordance with a fourth embodiment, as a cross-sectional diagram;

FIG. 5 shows the heat sink in accordance with the fourth embodiment, as a view from underneath.

FIG. 1 shows a side view of a retro-fit lamp 1 in accordance with a first embodiment, as a cross-sectional diagram. The lamp 1 has a heat sink 2 which is made up of two parts 3,4, namely a first heat sink part 3 made of a first heat sink material and, joined to it over an area, a second heat sink part 4 made of a second heat sink material. Affixed to an upper side 5 of the first heat sink part 3 is a light source 6, which has a light emitting diode (LED) 8 mounted on a circuit board 7. In this diagram, the main direction of radiation of the LED 8 is upwards. Into the path of the beam from the LED 8 is inserted an optical arrangement 9 (which is thus optically downstream from the LED 8), which redirects at least part of the light emitted by the LED 8, e.g. focuses or collimates it. For this purpose, the optical arrangement 9 can have a lens-shaped area. The light emerges from the lamp 1 through a light-transmitting (transparent or opaque) cover plate 10, which is thus downstream from the LED 8 and the optical arrangement 9. The first heat sink part 3 is joined on its rear side or underside 11, which faces away from the LED 8, to the second heat sink part 4 via a so-called TIM material 12, e.g. a heat conducting paste. Attached in turn on the second heat sink part 4 is a socket 13 for the power supply to the lamp 1, e.g. an Edison screw socket.

For the purpose of cooling the LED 8, the first heat sink material of the first heat sink part 3 consists of a copper alloy, so that the heat generated by the LED 8 can be distributed with high efficiency in the first heat sink part 3. The heat thus distributed, in particular, in the horizontal plane can then be transferred to the second heat sink part 4. Since the distributed heat is already substantially less at the interface to the second heat sink part 4, by comparison with the heat at the site of the LED 8, a second heat sink material which has a lower thermal conductivity than the copper alloy of the first heat sink material, but in exchange is much cheaper, e.g. PMMA or polycarbonate, suffices for its further dissipation. The TIM material 12 at the boundary surface between the two heat sink parts 3,4 ensures a good heat transfer. For the purpose of a good heat transfer, the light source 6, or more precisely the circuit board 8, is also joined to the first heat sink part 3 by means of a TIM material 14.

The dissipation of heat to the outside can take place as radiated heat or by heat convection at the outer side of the heat sink 2. For this purpose, the heat sink 2 may optionally be structured on its outer surface, on its first heat sink part 3 and/or on its second heat sink part 4, in order to enlarge the surface, and/or can be coated with a heater paint or something similar (not shown), in order to increase the heat radiation (radiation cooling).

FIG. 2 shows a side view of a retro-fit lamp 15 in accordance with a second embodiment, as a cross-sectional diagram. Unlike the first embodiment shown in FIG. 1, the first heat sink part 16 is now let into the second heat sink part 17. That is to say, the first heat sink part 16 is now joined thermally to the second heat sink part 17 not on one side only, but on several sides, namely via a lower surface 18 and a side surface 19. By this means, the boundary surface between the heat sink parts 16,17 is enlarged, which improves the heat transfer. For this purpose, the first heat sink part 16 is constructed not as a plate-shape, i.e. with a small height, but as a three-dimensional body with a vertical extension which in respect of heat transfer is not negligible, e.g. in the shape of a cuboid, a cube or a cylinder etc. Arranged with close-fitting faces on its upper side are the two heat sink parts 16,17.

FIG. 3 shows a side view of a retro-fit lamp 20 in accordance with a third embodiment, as a cross-sectional diagram. Unlike the second embodiment shown in FIG. 2 there are now ducts 21, passing through the retro-fit lamp 20 from every side, which are open to the outside. These ducts 21 pass at least partially through the heat sink 16,17, and indeed through one of the heat sink parts, in this case the second heat sink part 17, or through both heat sink parts, in this case the first heat sink part 16 and the second heat sink part 17. The first effect of the ducts 21 is that air can flow through them from end to end, wherein its at least partial contact with the heat sink 16,17 can produce a ‘flue effect’ which effects a particularly efficient heat dissipation through the ducts 21. In the case shown, the ducts 21 pass vertically upwards from beneath and hence also through the space between the heat sink 17 and the cover plate 10. The ducts 21 can be realized, for example, by tubes which are inserted into the retro-fit lamp 20 and are then affixed by means of a TIM material; or the ducts can, at least in the region of the heat sink 16,17, be formed by recesses in it. Naturally, the number, size and/or position of the ducts is not restricted to that shown for the exemplary embodiment. Thus, ducts can also have a position other than the vertical one shown, and/or various positions. A duct also does not have to be linear; it could also be branching.

FIG. 4 shows a side view of a heat sink 22 in accordance with a fourth embodiment, as a cross-sectional diagram. The first heat sink part 23 of the heat sink 22 has a basically cylindrical-shape, wherein a backward cylindrical-shaped recess 24 is introduced into the first heat sink part 23. Mounted on the front side 25 of the first heat sink part 23 is the light source 6, of which only the circuit board 7 and the LED 8 are shown here. A side surface 26 of the first heat sink part 23 is surrounded by the second heat sink part 27. The two heat sink parts 23,27 are arranged with their upper side faces in the same plane and lower side faces in the same plane. Into the recess 24 is inserted, for example, a driver 28 which is supplied with power by means of the socket and operates the light source 6 or the LED 8, as applicable. For this purpose, the driver 28 is joined to the light source 6 via at least one electrical conductor 29. For the purpose of a thermal coupling to the first heat sink part 23, the recess 24 with the driver 28 which it contains can be filled up with at least one heat-conducting material e.g. a TIM material 30. However, the heat-conducting material 30 is in principle not restricted and could include, for example, a mat, a paste, a gel, a foam, a fluid which hardens etc. It would also be possible to use several different heat-conducting materials 30, e.g. a TIM mat for greater heat transmission at ‘hot’ spots on the driver, combined with a TIM foam elsewhere.

FIG. 5 shows the heat sink 22 in accordance with the fourth embodiment, as a view from underneath. For the purpose of enlarging the heat-radiating area, the outside 31 of the side of the second heat sink part 27 is structured in such a way that it has longitudinally oriented fins 32 with a triangular cross-sectional shape. Here, the heat-conducting material 30 has TIM mats 30a for making thermal contact from the driver 28 to the first heat sink part 23 at each of the narrow positions, and elsewhere a TIM foam 30b.

Of course, the present invention is not restricted to the exemplary embodiments shown.

Thus, features of the different embodiments can also be combined with one another, e.g. the cooling fins with one of the lamps shown in FIGS. 1 to 3. The features of the embodiments can also be combined with the disclosure from other parts of the description, including the claims.

### LIST OF REFERENCE MARKS

1 Retro-fit lamp
2 Heat sink
3 First heat sink part
4 Second heat sink part
5 Upper side of the first heat sink part
6 Light source
7 Circuit board
8 LED
9 Optical arrangement
10 Cover plate
11 Underside
12 TIM material
13 Socket
14 TIM material
15 Retro-fit lamp
16 First heat sink part
17 Second heat sink part
18 Underside of the first heat sink part
19 Side surface of the first heat sink part
20 Retro-fit lamp
21 Duct
22 Heat sink
23 First heat sink part
24 Cylindrically-shaped recess
25 Front side of the first heat sink part
26 Side surface of the first heat sink part
27 Second heat sink part
28 Driver
29 Electrical conductor
30 Heat-conducting interface material
30a First TIM material
30b Second TIM material
31 Outer side
32 Fin

1. A heat sink for an illumination device, wherein the heat sink comprises several heat sink parts, wherein at least two of the heat sink parts include different heat sink materials.

2. The heat sink as claimed in claim 1, wherein at least one light source is attached to at least one first heat sink part made of a first heat sink material and no light source is attached to at least one second heat sink part made of a second heat sink material.

3. The heat sink as claimed in claim 2, for which the second heat sink material has a lower thermal conductivity and/or a lower density than the first heat sink material.

4. The heat sink as claimed in claim 3, for which the value of the thermal conductivity of the first heat sink material is more than 10 W/(m·K).

5. The heat sink as claimed in claim 2, wherein the first heat sink material has at least one metal, one plastic and/or one ceramic.

6. The heat sink as claimed in claim 3, for which the value of the thermal conductivity of the second heat sink material is more than 1 W/(m·K).

7. The heat sink as claimed in claim 2, wherein the second heat sink material has a plastic and/or a ceramic.

8. The heat sink as claimed in claim 2, wherein the second heat sink material is electrically insulating.

9. The heat sink as claimed in claim 2, wherein at least one heat sink part has a recess for accommodating a driver.

10. The heat sink as claimed in claim 2, wherein the outside of at least one second heat sink part is structured or coated.

11. The heat sink as claimed in claim 2, wherein a driver is thermally coupled to at least one heat sink part.

12. The heat sink as claimed in claim 1, having at least one duct right through it.

13. The heat sink as claimed in claim 1, wherein at least two heat sink parts are coupled to one another by a thermal interface material.

14. An illumination device, in particular a retro-fit lamp, with at least one heat sink as claimed in claim 1, wherein at least one light source is attached to the heat sink.

15. The heat sink as claimed in claim 2, wherein the at least one light source incorporates at least one semiconductor light source.

16. The heat sink as claimed in claim 3, for which the value of the thermal conductivity of the first heat sink material is than 100 W/(m·K).

17. The heat sink as claimed in claim 3, for which the value of the thermal conductivity of the second heat sink material is more than 5 W/(m·K).

18. The heat sink as claimed in claim 1, wherein at least two heat sink parts are joined across an area by a thermal interface material.

19. The heat sink as claimed in claim 2, wherein the at least one light source incorporates at least one semiconductor light emitting diode.
